(19) United States
(12) Patent Application Publication
(10) Pub. No.: US 2006/0123690 A1
(43) Pub. Date: Jun. 15, 2006

(54) Fish hook and related methods

(76) Inventor: Mark C. Anderson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/013,261

(22) Filed: Dec. 14, 2004

(51) Int. Cl. A01K 83/00

(52) U.S. Cl. 43/43.16

(57) ABSTRACT

The present invention is related to fish hooks including metallic glass, and related methods.

### FIELD OF THE INVENTION

The present invention is related to fish hooks made from material including metallic glass (also known as amorphous metal or glassy metal or glass-like metal) and related methods.

### BACKGROUND OF THE INVENTION

For quite some time, there has been a demand for open-ocean fish such as tuna (e.g., bluefin, yellowfin, bigeye, and albacore), swordfish, mahi-mahi, shark, and the like. Such open-ocean fish can grow to hundreds of pounds and are known for their fighting strength. Harvesting such open-ocean fish has been and continues to be commercially significant.

Because of the size and strength of many open-ocean fish, commercial fishing equipment needs to be relatively large and heavy duty. Indeed, commercial fishing hooks are significantly larger and more heavy duty than metal wire hooks used to fish small fresh-water fish such as bluegill and the like. FIG. 1 shows an example of a typical commercial fishing fish hook. Fish hook 10 includes an eye 15, shank 25, bend 30, point 35, and barb 40. In general, two important dimensions of a fish hook are the gape 45 and/or the bite/throat 46. These features are discussed further below. Fish hook 10 is commonly made out of a high strength material such as conventional metal formulations (e.g., stainless steel) and is relatively large (e.g., such as the saltwater hooks available from VMC Inc., Saint Paul, Minn., USA).

One would think that a conventional fish hook could be fabricated simply and in one piece. This is not the case, because such hooks lack the strength, durability, impact resistance, and/or deformation resistance to be practically useful. The integrity of the hooks is further confounded by the tendency of conventionally used metal formulations to be relatively incompatible as much as might be desired with respect to one-step fabrication processes, e.g., injection molding, casting processes, and the like. As one problem, the formed part tends to shrink too much and/or develop too much porosity upon cooling. It is believed that this occurs in that conventionally used molten metal goes through a liquid-to-solid transformation that can result in a sudden, discontinuous volume change upon solidification. Whatever the mechanism, the resulting part may suffer from low metallurgical soundness and quality.

Molding and casting problems are severe enough that, notwithstanding the added manufacturing complexity, commercial fishing hooks are typically manufactured in multiple steps (even 7 distinct steps is typical) by forming and attaching (e.g., welding) two or more parts together to form a fish hook. For example, as shown, hook 10 includes a welded joint 20 that joins together eye 15 to shank 25. Stainless steel hooks may include attaching together even more than two individual pieces to form a hook. Typically, after welding, a fish hook is heat-treated. Such multi-step manufacturing of commercial fishing hooks can reduce and/or complicate manufacturing yield. The extra steps also significantly manufacturing time and cost.

The use of multiple parts and multi-step manufacturing limits design flexibility in that it becomes uneconomical for a fish hook manufacturer to invest in tooling for additional fish hook designs. It would be very desirable to simplify the manufacture of fish hooks. It would also be desirable to ease the economics of developing and manufacturing additional fish hook designs.

Commercial harvesting of open-ocean fish can be performed using a variety of fishing techniques, e.g., trotlines and longlines/trawl lines/setlines. Longline fishing combines the quality of “one-at-a-time-handling” fishing technique with the efficiency of the “hook-and-line” longlining fishing technique. Longline fishing for open-ocean fish species on a commercial scale can include attaching thousands of baited hooks to one or more fishing lines. These lines are coupled to one or more fishing vessels that patrol a desired fishing territory, pulling these lines astern.

During commercial fishing, the efficiency of a particular fishing method is desirably as high as possible to save time and money to the fisherman and ultimately to save money to the consumer. Efficiency can be measured by one or more criteria such as average fish caught per line per unit time (line efficiency); average fish caught per gallon of fuel consumed (fuel efficiency), average fish caught per unit time (time efficiency), average fish caught per hook per unit time (hook efficiency), and/or the like. These efficiencies are impacted by a variety of factors.

For example, a longline fishing line typically includes at least one mainline with secondary lines branching off of the mainline. Baited hooks (e.g., hook 10) are set far apart from each other on the fishing line. Monofilament fishing line is preferred as it tends to reduce drag. It is also lightweight and strong. These features are important, because some longlines can be up to 7 miles, up to 30 miles, even up to 80 miles, long and carry up to, e.g., 10,000 hooks similar to hook 10. These line(s) are towed below the surface of the water astern fishing vessels so that large numbers of open-ocean fish can be caught. Because of the large number of conventional metal hooks involved, the cumulative weight of the lines and hooks is tremendous and significantly impacts fuel usage by the towing vessel. It would be desirable to help reduce the impact that these lines have upon fuel usage. This could extend the range of a vessel and/or lower fishing costs overall.

Additionally, hooks are damaged and/or lost for one reason or another, requiring replacement. Hooks fail for a variety of reasons. For example, many of the materials (e.g., stainless steel) conventionally used to make fish hooks start to corrode soon after being exposed to the open-ocean waters (i.e., salt-water). Many of the fine features of a hook responsible for hooking and holding a fish (e.g., point 35 and barb 40) quickly corrode to a point such that their ability to penetrate and/or hold a fish is reduced or lost. A severely corroded hook is also more prone to damage and/or loss.

As another example, the many points of attachment (e.g., weld 20) among parts in many conventional fish hooks can create points of weakness such that when a large open-ocean fish (e.g., tuna) hits the hook with sufficient force, the hook may unduly bend or completely fail (i.e., break) at the point or points of weakness causing the fish hook utility to be reduced or lost. A common cause of losing a hook similar to hook 10 in tuna fishing is by a tuna hitting hook 10 with sufficient force such that hook breaks at weld 20 causing the lower part of hook 10 to fall from the fishing line.

Apart from attachment points, the impact resistance of conventional metal parts themselves (e.g., stainless steel fish hooks) may be such that a large fish such as a tuna can sometimes impact the hook with such force that the hook literally snaps apart and falls from the fishing line. In such a case, the utility of the fish hook is completely lost.

The metal material (e.g., stainless steel) of many conventional commercial fish hooks can be susceptible to undue, permanent deflection upon impact by an open-ocean fish species such as a large tuna. Many times, when a large ocean fish such as a tuna hits a conventional metal hook (e.g., to take the bait), the tuna hits the hook with sufficient force to cause significant deflection or other deformation (e.g., up to 90 degrees or more). Deflecting to an undue degree causes the utility of the hook for catching a fish to be reduced or lost. The resulting deformation tends to be permanent unless the hook is removed from service for replacement or repair. Conventional metal hooks tend to lack the memory required for the hook to naturally return to a position such that the hook's utility is regained.

If the utility of a hook is lost or reduced to an undue degree, a new hook is desirably attached to the line to replace the old hook. Replacing hooks can involve significant labor, material, down time, and other costs, which ultimately increases the cost to the consumer. The costs associated with attaching and replacing, as needed, many hooks is significant. It would be desirable to reduce the labor, materials, costs, and down time associated with maintaining lines so that a vessel and its crew can spend more time fishing and less time getting ready to fish.

There is a continuing need for new and improved fish hooks, especially commercial fishing fish hooks.

### SUMMARY OF THE INVENTION

In one aspect, the present invention provides a fish hook made from one or more materials including an amorphous metallic alloy, sometimes referred to as a metallic glass. In preferred embodiments, the hook has a one-piece structure and more preferably is formed substantially entirely from metallic glass.

Fish hooks made from metallic glasses have many advantages uniquely beneficial in the fishing industry. Firstly, as one consequence of the high yield strength, superior elastic limit, high corrosion resistance, high hardness, superior strength-to-weight ratio, high wear-resistance, and others associated with metallic glasses, fish hooks made from such materials can be fabricated, if desired, using casting and molding processes easily manufactured in one step and, if desired, in one unitary piece. The metallic glass material is quite compatible with such fabrication processes, and the resultant hooks are quite strong and durable in contravention to conventional wisdom associated with fish hook manufacture and use.

Also, being able to form a unitary, undivided fish hook of the present invention via, e.g., injection molding, can increase development and design flexibility.

Fish hooks made from one or more materials including metallic glass would tend to have significantly longer-lasting utility than conventionally formulated hooks. This is true for a variety of reasons. Firstly, because the inventive hooks can be fabricated in one piece, fish hooks can be made without attachment points (e.g., weld points) that can be sites of failure.

The fish hooks further would possess significantly greater strength, durability, impact resistance and “memory” than conventional fish hooks. Consequently, these fish hooks are stronger and less likely to break or deflect to an undue degree during fishing. For example, a fish hook made from a conventional metal formulation may permanently deflect 90 or more degrees under a load indicative of the impact upon the hook of a large ocean fish, e.g., a tuna. In contrast, a fish hook in accordance with the present invention may deflect only 10 degrees under similar conditions. The hook of the present invention thus retains its utility, while that of the conventional hook would be lost.

Even if a load were severe enough to cause more significant deflection, the hooks of the present invention benefit from deformation “memory” (i.e., an ability to return to the original manufactured shape and configuration). In contrast, a conventional hook will tend to permanently deform with an increased risk of lost utility.

The fish hooks of the present invention also are very corrosion resistant, even in salt water. This characteristic, too, helps the fish hooks have a much longer service life than a fish hook made from conventional metal formulations. Of particular importance, even fine features such as a point and/or a barb of a fish hook according to the present invention resist salt-water corrosion for long periods of time. In contrast, similar fine features of conventional hooks begin to corrode virtually immediately upon immersion in salt water and often show significant corrosion damage after only a few days.

In short, the fact that the hooks are less susceptible to damage or loss means that, on average, a hook of the present invention stays in service without need of repair or replacement for longer periods of time. Because the hooks are stronger, more impact resistant, and more resistant to deformation, more fish per deployed hook can be caught. Further, because fishermen will spend less time replacing or repairing lost or damaged hooks, more work time can be devoted to actual fishing and less to repair and maintenance of the lines bearing the hooks.

Not only are the hooks of the present invention, strong, durable, corrosion resistant, and deformation-resistant, the hooks of the present invention are also dramatically lighter than their conventional counterparts. Weight savings of as much as 30% per hook could be observed. Given the length of fishing longlines and the voluminous number of hooks carried by these lines, the cumulative weight savings can be quite significant. Consequently, lines bearing these hooks have a lesser impact upon fuel usage of towing vessels.

In short, the fish hooks of the present invention offer substantial improvements in line efficiency, fuel efficiency, time efficiency, and hook efficiency of fishing operations.

In another aspect, the present invention relates to a method of fishing using a fish hook comprising a metallic glass.

In another aspect to present invention relates to a method of manufacturing a fish hook. A candidate metallic glass precursor composition is provided. The precursor composition is tested to obtain test data indicative of the performance of a fish hook fabricated from materials comprising the precursor. Information comprising the test data is used to manufacture and market a fish hook derived from ingredients comprising a metallic glass.

In another aspect, to present invention relates to a method of marketing a fish hook made out of material comprising metallic glass. A fish hook product line comprising a plurality of fish hooks is provided. The fish hooks comprise a metallic glass. The fish hook product line is marketed in association with information indicative of using the fish hooks of the product line to fish.

### BRIEF DESCRIPTION OF THE DRAWINGS

FIG. 1 illustrates a fish hook of the prior art.

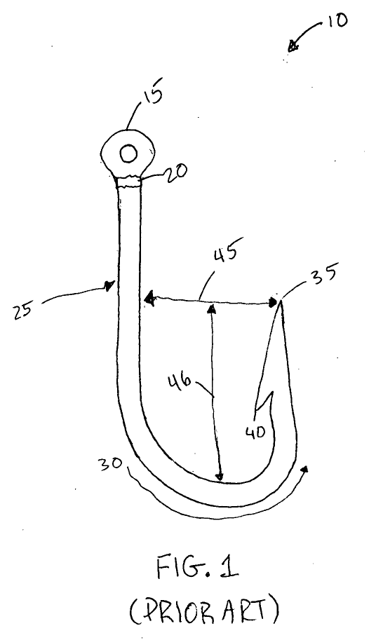

FIG. 2 illustrates a fish hook according to the present invention.

### DETAILED DESCRIPTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

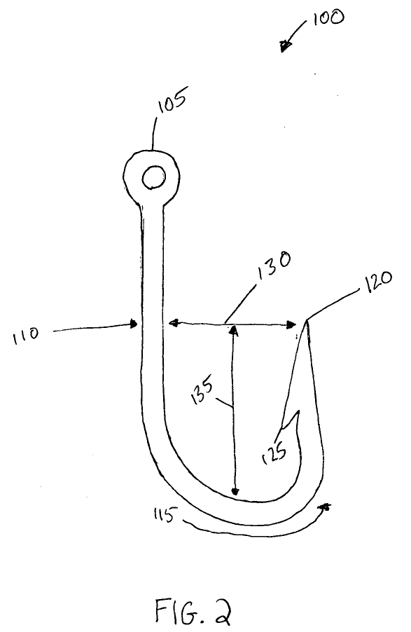

An exemplary fish hook according to the present invention is described with reference to FIG. 2. As shown, fish hook 100 includes eye 105, shank 110, bend 115, point 120, and barb 125. In general, two important dimensions of a fish hook are the gape 130 and/or the bite/throat 135. Gape 130 is the distance between point 120 and shank 110. Bite/throat 135 is the distance from the apex of bend 115 to its intersection with gape 130.

In general, the eye of a fish hook includes many variations such as a bull/ringed eye, a tapered eye, a looped eye, a needle eye, and the like. A bull/ringed eye forms a circle and is probably the most common. A tapered eye forms a ring that decreases in diameter and is relatively more thin than the rest of the fish hook. A tapered eye is typically used for tying dry flies and for bait fishing, however, a tapered eye may be relatively more weak and may open or even break under pressure. A looped eye is oval in shape and may be tapered at the end. A needle eye is similar to the eye of a sewing needle. A needle eye is strong and tends to be used for big-game fishing. Also, the eye of a hook can be parallel or perpendicular to the plane of the hook. Further, fish hook eyes can be straight, bent forward, or bent backward. As shown, eye 105 is a ringed eye that is straight and parallel to the plane of the rest of hook 100.

The shank of a fish hook is the part of the hook which extends from the bend of the hook to the eye of the hook. The shank of a fish hook comes in a variety of shapes such as, e.g., straight, curved, or sliced. A straight fish hook shank is generally substantially straight from the eye of the hook to the bend of the hook. A curved fish hook shank is generally curved from the eye of the hook to the bend of the hook. A sliced shank has one or more barbs cut into the shank. The shank can be a variety of lengths, but typically come in sizes known as regular, short, or long. A regular shank tends to be used for “all-around” fishing. A short shank tends to be used to hide the hook inside bait so that a fish is less likely to see the hook. And a long shank tends to be used to hinder a fish from cutting the fishing line with its teeth and/or to hinder a fish from swallowing the hook and bait. As shown, shank 110 is a straight, regular shank.

In general, the point of a fish hook is a sharp end of the hook that penetrates a fish. A fish hook point preferably penetrates a fish with as little force as possible. Also, a fish hook point preferably stays sharp for a long period of time so as to preserve the utility and efficiency of the fish hook. A wide-variety of types of points are known such as, e.g., spear point, hollow point, needle point, rolled-in point, a knife-edge point, and diamond/triangle points. A spear point follows a straight line from a point to a barb. A hollow point is rounded out down to about the tip of the barb and tends to be thin and shallow. A rolled-in point is curved back towards the eye of the hook to allow for a direct line pull and is relatively more difficult for a fish to throw off. A needle point is rounded and narrows the point to the barb to resemble a claw. A knife-edge point has flat sides on the inside portion of the point. A diamond/triangle point has three cutting edges used to penetrate fish having relatively hard mouths. As shown, point 120 is a knife-edge point.

A fish hook barb is a projection extending, e.g., backwards from a point to help prevent the fish from unhooking after the point has penetrated the fish. Features of the barb such as barb angle and elevation help influence its holding ability. Similar to a fish hook point, a barb preferably maintains its features (e.g., maintains its angle and elevation) for a long period of time so as to preserve the utility and efficiency of the fish hook.

Fish hooks come in a variety of sizes determined by their pattern. Typically, a fish hook size is given in terms of the width of its gape (e.g., gape 130) of the hook. Commercial fishing hooks such as fish hook 100 are relatively large. A preferred commercial fish hook size is commonly known as size 12/0.

A fish hook according to the present invention is made from material including an amorphous metallic alloy, commonly referred to as a metallic glass. A metallic glass is a metallic alloy that is amorphous or glassy at low temperatures. A metallic glass is formed by solidification of alloy melts by cooling the alloy to a temperature below its glass transition temperature at a cooling rate sufficient to substantially prevent appreciable nucleation and crystallization. Such cooling rates can be on the order of 10⁴ to 10⁶ K/sec. Ordinary metals and alloys crystallize when cooled from the liquid phase.

The resistance of a metallic glass to crystallization can be related to the cooling rate required to form the glass upon cooling from the melt. This is an indication of the stability of the amorphous phase upon heating above the glass transition temperature during processing. It is desirable that the cooling rate required to suppress crystallization be in the order of from 1 K/s to 10³ K/s or even less. As the critical cooling rate decreases, greater times are available for processing and larger cross sections of parts can be fabricated. Further, such alloys can be heated substantially above the glass transition temperature without crystallizing during time scales suitable for industrial processing.

Alloys of zirconium and/or titanium, copper and/or nickel, other transition metals and beryllium have been found which have greater resistance to crystallization so that less restrictive cooling rates can be utilized to help form amorphous bodies of substantial thickness. That is, the critical cooling rate is less than 10³ K/S so that thick amorphous bodies can be cast. Preferably, a metallic glass formulation for use in the present invention has a critical cooling rate less than 10³ K/s.

Preferred metallic glass formulations include those that can form a unitary fish hook of a size and shape that is suitable for commercial fishing (e.g., unitary fish hook 100). As used herein, a “unitary fish hook” means an entire fish hook that is an undivided unit. For example, cast molding an entire fish hook such as fish hook 100 produces a “unitary fish hook.” In contrast, fish hook 10 of the prior art is not a unitary fish hook because it is made from more than one piece (i.e., eye 15 is welded to shaft 25). Preferred metallic glass formulations for use in the present invention include formulations also known as a bulk-solidifying amorphous alloys or metals. The term “bulk-solidifying amorphous alloys” refers to a family of amorphous alloys that may be cooled at rates of about 500 K/sec or less from their molten state to form objects having thicknesses of 1.0 mm or more while maintaining a substantially amorphous atomic structure. Bulk-solidifying amorphous alloys' ability to form objects having thicknesses of 1.0 mm or greater is a substantial improvement on conventional amorphous alloys, which are typically limited to articles having thicknesses of 0.020 mm, and which require cooling rates of 105 K/sec or more. Bulk-solidifying amorphous alloys, when properly formed from the molten state at sufficiently fast cooling rates, have high elastic limit typically in the range of from 1.8% to 2.2%. Further, these amorphous alloys may show bending ductility ranging from a few percent in samples of 0.5 mm thick or more to as high as 100% as in some cases.

Preferred metallic glass formulations include the Zr—Ti based metallic glass formulations disclosed in, e.g., U.S. Pat. Nos. 5,032,196; 5,288,344; 5,368,659; 5,618,359; and 5,735,975, and U.S. Pub. No. 2003/0075246 (each of whose disclosures is incorporated herein by reference in its entirety). Preferred metallic glass formulations for use in the present invention include such formulations commercially available from LIQUIDMETAL® Technologies in Lake Forest, Calif.

As used herein, the term “Zr—Ti based” is understood as incorporating those bulk-solidifying amorphous alloy compositions wherein the total of Zr and Ti comprises the largest atomic percentage of metal components in the subject alloy composition.

Methods of making feedstocks of bulk-solidifying amorphous alloys are known. An exemplary method of making bulk-solidifying alloy for use in the present invention is disclosed in, e.g., U.S. Pub. No. 2003/0075246.

Optionally, one or more additives can be used in a metallic glass formulation for use in the present invention. In preferred embodiments at least 50 percent, preferably 75 percent, even more preferably 90 percent, and even more preferably substantially all of the material in a fish hook according to the present invention is metallic glass.

A fish hook according to the present invention can be made using methods known or yet to be discovered. Practical and cost-effective methods to produce one or more fish hooks made out of material including metallic glass, and particularly for fish hooks having intricate and precision shapes include metal mold casting methods, such as high-pressure die-casting, as these methods provide suitable cooling rates. Suitable methods to cast metallic glass fish hooks are disclosed in, e.g., U.S. Pat. Nos. 5,213,148; 5,279,349; 5,711,363; 6,021,840; 6,044,893; and 6,258,183, and U.S. Pub. No. 2003/0075246 (each of whose disclosures is incorporated herein by reference in its entirety). Optionally, casting a fish hook of the present invention can be carried out under an inert atmosphere or in a vacuum.

What is claimed is:

1. A fish hook, comprising one or more materials including a metallic glass.

2. The fish hook of claim 1, wherein at least 50 percent of the one or more materials is metallic glass.

3. The fish hook of claim 2, wherein substantially all of the one or more materials is metallic glass.

4. A method of making a fish hook comprising the step of forming a fish hook from one or more materials comprising a metallic glass.

5. The method of claim 4, wherein said forming step comprises:
providing a molten metallic glass precursor composition in a fish hook mold; and
solidifying the precursor under conditions effective to form a fish hook comprising a metallic glass.

6. The method of claim 4, wherein said forming step comprises forming a one-piece fish hook.

7. The method of claim 4, wherein the metallic glass comprises a bulk-solidifying amorphous metal alloy.

8. A method of fishing, comprising the step of using a fish hook comprising a metallic glass.

9. A method of manufacturing a fish hook, the method comprising the steps of:
providing a candidate metallic glass precursor composition;
testing the precursor composition to obtain test data indicative of the performance of a fish hook fabricated from materials comprising the precursor; and
using information comprising the test data to manufacture and market a fish hook comprising a metallic glass.

10. A method of marketing a fish hook made out of material comprising metallic glass, comprising the steps of:
providing a fish hook product line comprising a plurality of fish hooks, wherein the fish hooks comprise a metallic glass; and
marketing the fish hook product line in association with information indicative of using the fish hook product line to fish.
